(19) United States
(12) Patent Application Publication
(10) Pub. No.: US 2015/0115684 A1
(43) Pub. Date: Apr. 30, 2015

(54) FOOT SUPPORT FOR A VEHICLE SEAT AND VEHICLE SEAT

(71) Applicant: JOHNSON CONTROLS COMPONENTS GMBH & CO. KG, Kaiserslautern (DE)

(72) Inventors: Erik Weber, Bedesbach (DE); Eckhard Kirch, Bann (DE)

(21) Appl. No.: 14/391,243

(22) PCT Filed: Jun. 20, 2013
(86) PCT No.: PCT/EP2013/062906

§ 371 Date: Oct. 8, 2014

(30) Foreign Application Priority Data
Jun. 26, 2012 (DE) 10 2012 012 849.5

(51) Int. Cl. B60N 3/06; B60N 2/44

(52) U.S. Cl. CPC B60N 3/063; B60N 2/443; B60N 2002/4425
USPC 297/423.15; 297/423.19

(57) ABSTRACT

A foot support (30) for a vehicle seat (1) includes a footrest (32) which is movable from an out-of-use position into a use position. The footrest (32) is guided by a linear guide during the movement from the out-of-use position into the use position. A drive unit (34) is provided for driving the footrest (32). The drive unit (34) includes at least one spindle (40) with at least one spindle nut (42, 44), which is arranged on the spindle (40) and is rotatable relative to the spindle (40). The spindle (40) runs in the transverse direction and includes two threaded regions (46, 48) with threads oriented in opposed directions. A vehicle seat (1) is provided with the foot support (30).

### CROSS REFERENCE TO RELATED APPLICATIONS

This application is a United States National Phase Application of International Application PCT/EP2013/062906 filed Jun. 20, 2013 and claims the benefit of priority under 35 U.S.C. §119 of German Patent Application DE 10 2012 012 849.5 filed Jun. 26, 2012, the entire contents of which are incorporated herein by reference.

### FIELD OF THE INVENTION

The invention relates to a foot support for a vehicle seat with a footrest which is movable from a position of non-use into a position of use, wherein the footrest is guided by means of a linear guide during the movement from the position of non-use into the position of use, a drive unit is provided for driving the footrest, and the drive unit comprises at least one spindle having at least one spindle nut which is arranged on the spindle and which is rotatable relative to the spindle. The invention further relates to a vehicle seat comprising the foot support.

### BACKGROUND OF THE INVENTION

A generic vehicle seat which has a generic foot support is disclosed in DE 38 15 936 C1. The foot support in this case is attached to the rear face of the vehicle seat, in particular a front seat, and serves to support the feet of a vehicle occupant who is seated on a rear seat located to the rear of the front seat.

The foot support comprises a footrest which is pivotably mounted on the vehicle seat about an axis extending in the transverse direction, from a folded up position of non-use into a folded-down position of use. The footrest is held in the position of use and in the position of non-use by a spring. The vehicle occupant may move the footrest manually from its position of use into its position of non-use and in the opposing direction. During such a movement, the respective dead center point of the spring also has to be overcome. In the position of use, the footrest bears against the vehicle floor, whereby a longitudinal displacement of the vehicle seat is hampered.

DE 103 41 843 A1 discloses a foot support having a spindle arranged below an instrument panel of a motor vehicle, by means of which a foot support is able to be moved in a linear displaceable manner.

### SUMMARY OF THE INVENTION

An object of the invention is to improve a foot support and a vehicle seat of the type mentioned in the introduction.

According to the invention, the foot support for a vehicle seat comprises a footrest which is movable from a position of non-use into a position of use, wherein the footrest is guided by means of a linear guide during the movement from the position of non-use into the position of use, wherein a drive unit is provided for driving the footrest, wherein the drive unit comprises at least one spindle having at least one spindle nut which is arranged on the spindle and which is rotatable relative to the spindle, wherein the spindle extends in the transverse direction and wherein the spindle comprises two threaded regions with threads oriented in opposing directions.

As the footrest is guided by means of a linear guide when moved from the position of non-use into the position of use, no contact of the footrest with the vehicle floor is provided or required. Thus the footrest in the position of use also does not hinder a longitudinal displacement of the vehicle seat. Moreover, by means of the embodiment according to the invention the foot support is particularly economical in terms of constructional space. Moreover, the distribution of force from the drive unit onto the footrest is able to be implemented relatively uniformly.

The movement of the footrest from its position of non-use into its position of use thus preferably takes place in a translatory manner.

A guide for the footrest is able to be constructed relatively easily if the movement of the footrest from the position of non-use into the position of use is carried out exclusively in a translatory manner. The movement of the footrest from the position of use into the position of non-use is also advantageously carried out exclusively in a translatory manner.

Advantageously, the movement of the footrest from the position of non-use into the position of use is carried out approximately counter to the direction of travel, i.e. out of the vehicle seat.

Accordingly, the movement of the footrest from the position of use into the position of non-use is advantageously carried out approximately in the direction of travel, i.e. into the vehicle seat.

The drive unit advantageously comprises an electric motor. Thus a manual movement of the footrest is not required.

The construction of the drive unit is able to be implemented relatively easily if the spindle is rotatably mounted.

In this case, the two threaded regions are advantageously arranged adjacent to one another relative to the longitudinal axis of the spindle.

Preferably, the linear guide comprises two outer rails and two inner rails, wherein the inner rails are displaceably guided in the outer rails.

Advantageously, two spindle nuts are specifically provided, said spindle nuts being respectively arranged on one of the two threaded regions of the spindle.

According to an advantageous embodiment of the invention at least one coupler is attached at one end to the spindle nut.

In this case, the coupler is preferably pivotably mounted on the spindle nut about an axis extending in the vertical direction.

In this case, the other end of the coupler is preferably pivotably mounted at a point of articulation on the footrest about an axis extending in the vertical direction.

Advantageously, in this case the vehicle seat comprises a seat part and a backrest, wherein the footrest in the position of non-use is located in a space between the backrest and the seat part.

Preferably, in this case the vehicle seat comprises a seat part which comprises a seat frame with two side parts extending approximately in the direction of travel, wherein the spindle is rotatably mounted on the two side parts of the seat frame.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a vehicle seat;

FIG. 2 is a side view of a vehicle seat with an extended foot support;

FIG. 3 is a perspective view of a vehicle seat with a retracted foot support;

FIG. 4 is a perspective view of a vehicle seat with an extended foot support;

FIG. 5 is a plan view of a retracted foot support; and

FIG. 6 is a plan view of an extended foot support.

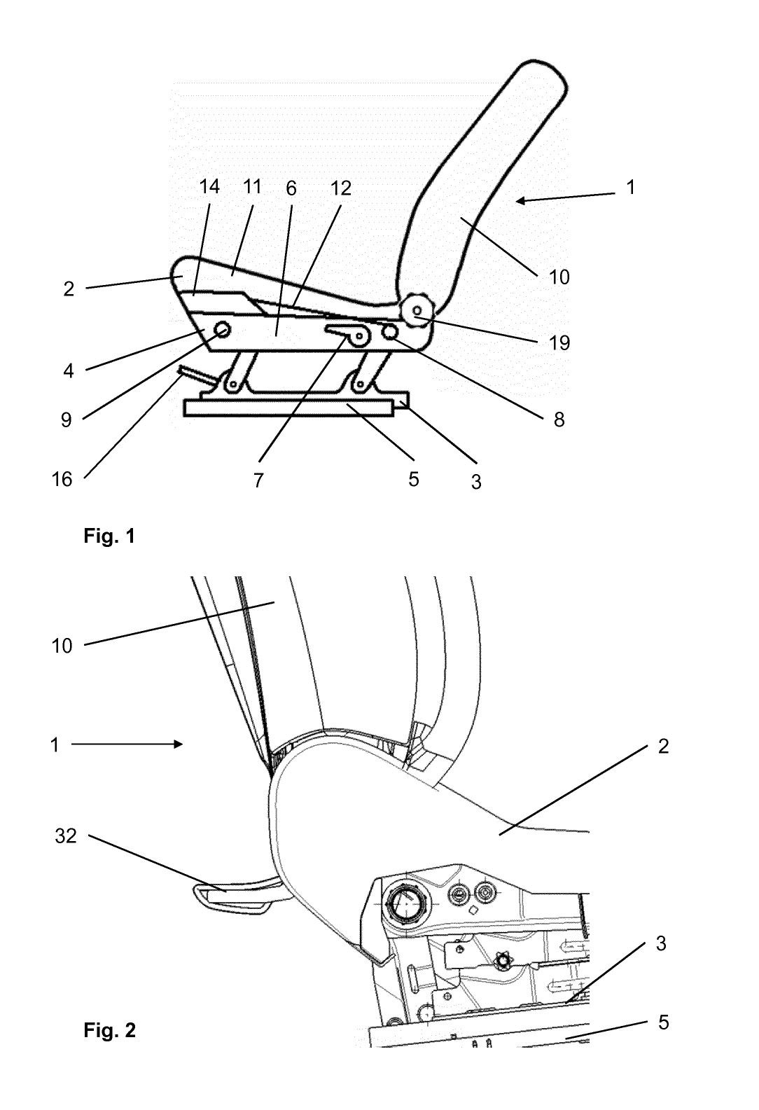

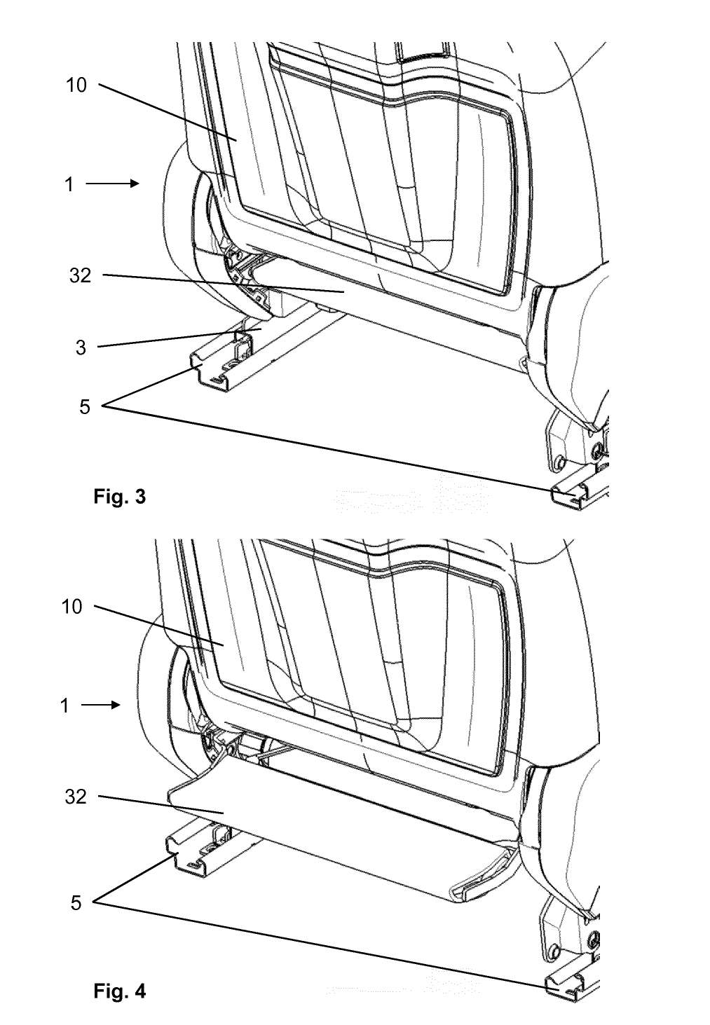

### DESCRIPTION OF THE PREFERRED EMBODIMENTS

Referring to the drawings in particular, a vehicle seat 1 for a motor vehicle comprises a seat part 2 and a backrest 10 which is attached thereto and which is able to be adjusted in inclination.

The arrangement of the vehicle seat 1 inside the vehicle and the usual direction of travel thereof define the directional information used hereinafter. In this case, a direction oriented perpendicular to the ground is denoted hereinafter as the vertical direction and a direction perpendicular to the vertical direction and perpendicular to the direction of travel is denoted hereinafter as the transverse direction.

By means of a backrest adjustment fitting 19 which is arranged to the side and which is able to be operated manually, the backrest 10 is able to be adjusted in inclination, which means that the angle between the seat part 2 and the backrest 10 is adjustable. Alternatively, an electrical drive is also conceivable.

The height of the seat part 2 and in the present case also the backrest 10 of the vehicle seat 1 are able to be adjusted above the vehicle floor by means of a height adjuster. In the present case, a drive device 7 which is able to be operated manually is provided for driving the height adjuster. Alternatively, an electrical drive is also conceivable.

The vehicle seat 1 is longitudinally adjustable by means of a longitudinal adjuster which has two lower rails 5 connected to the vehicle floor and two upper rails 3 connected to the vehicle seat 1, which means that the seat part 2 is able to be adjusted together with the backrest 10 in the longitudinal direction which approximately corresponds to the direction of travel. To this end, each of the upper rails 3 is displaceably guided, respectively in one of the lower rails 5 extending parallel in the longitudinal direction, and is able to be locked to the respective lower rail 5 by means of a locking device. The locking device is able to be unlocked by means of an unlocking bar 16. Alternatively, an electrical drive is also conceivable here.

In this case, the longitudinal direction extends perpendicular to the transverse direction but in the present case slightly inclined relative to the direction of travel and thus also approximately perpendicular to the vertical direction.

The seat part 2 comprises a seat frame 4 which comprises two side parts 6 extending approximately in the direction of travel and a rear transverse tube 8 extending in the transverse direction, attached in the region of the seat frame 4 which is located to the rear in the direction of travel. A further front transverse tube 9 also extending in the transverse direction is arranged in the region of the seat frame 4 which is located to the front in the direction of travel. The rear transverse tube 8 and the front transverse tube 9 are connected to the side parts 6 of the seat frame 4.

The seat part 2 further comprises a seat shell 14 which bears against the side parts 6 and against the front transverse tube 9 of the seat frame 4. A spring mat 12 is attached to the seat shell 14 and to the rear transverse tube 8 of the seat frame 4, said spring mat comprising a plurality of spring wires 20.

The spring wires 20 of the spring mat 12 are designed in a meandering manner and extend substantially in the longitudinal direction. This means that along the length of a spring wire 20 regions extending approximately in the longitudinal direction alternate with regions extending approximately in the transverse direction. The spring wires 20 are able to be deformed in a resilient manner. When loaded by the weight of an occupant the spring wires 20 of the spring mat 12 flex downwards in the vertical direction and in this manner provide a suspension of the seat part 2.

A seat cushion 11 is provided on the side of the seat shell 14 remote from the vehicle floor and the spring mat 12, said seat cushion being configured as a foam part. In addition, the backrest 10 is upholstered with a foam part and, in the same manner as the seat cushion 11, covered by a cover. The seat cushion 11 and the spring mat 12 considerably increase the seating comfort for an occupant of the vehicle seat 1.

A foot support 30 is provided in a transition region between the backrest 10 and the seat part 2. The foot support 30 comprises a footrest 32 which is able to be moved in a translatory manner from a position of non-use into a position of use and from the position of use back into the position of non-use.

In the position of non-use, the footrest 32 is located in a space between the backrest 10 and the seat part 2 in the vertical direction below the backrest adjustment fitting 19 and above the rear transverse tube 8. In the present case, the footrest 32 does not protrude from the vehicle seat 1. If the footrest 32 is in the position of non-use, the foot support 30 is retracted. It is also conceivable that in the position of non-use the footrest 32 protrudes partially from the vehicle seat 1.

In the position of use the footrest 32 is displaced to the rear relative to the position of non-use in the longitudinal direction and protrudes fully from the vehicle seat 1. In this case, the footrest 32 is located to the rear of the seat part 2 in the longitudinal direction. If the footrest 32 is in the position of use, the foot support 30 is extended. It is also conceivable that in the position of use the footrest 32 still partially protrudes into the vehicle seat 1.

A linear guide is provided for the translatory movement of the footrest 32 from the position of non-use into the position of use, said linear guide comprising two outer rails 56 and two inner rails 58, wherein the inner rails 58 are displaceably guided in the outer rails 56. The outer rails 56 encompassing the footrest 32 in the transverse direction are arranged on the seat part 2 and extend in the longitudinal direction. The inner rails 58 are fastened in the transverse direction to the outside of the footrest 32. Thus, in the present case, the footrest 32 is able to be moved to the front and to the rear in the longitudinal direction by the linear guide, exclusively in a translatory manner. It is also conceivable that the outer rails 56 extend in a direction obliquely to the longitudinal direction but preferably perpendicular to the transverse direction.

A drive unit 34 is provided for driving the footrest 32, said drive unit comprising an electric motor 36 which in the present case is designed as a geared motor. The drive unit 34 further comprises a spindle 40 which is rotatably mounted on the seat part 2, in the present case on the two side parts 6 of the seat frame 4 and extends parallel to the rear transverse tube 8 in the transverse direction. The spindle 40 is able to be driven by the electric motor 36.

The spindle 40 comprises a first threaded region 46 which in the present case has a right-hand thread. The spindle 40 further comprises a second threaded region 48 which in the present case has a left-hand thread. The threads of the two threaded regions 46, 48 are thus oriented in opposing directions. The threaded regions 46, 48 are arranged adjacent to one another in the transverse direction and in each case extend over approximately half the length of the spindle 40 in the transverse direction.

A first spindle nut 42 is arranged on the first threaded region 46 of the spindle 40, said first spindle nut having a right-hand internal thread and being rotatable relative to the first threaded region 46. In addition, a second spindle nut 44 is arranged on the second threaded region 48 of the spindle 40, said second spindle nut having a left-hand internal thread and being rotatable relative to the second threaded region 48. When rotating a spindle nut 42, 44, relative to the threaded region 46, 48, on which it is arranged, the spindle nut 42, 44, is displaced along the longitudinal axis of the spindle 40.

A first coupler 52 is attached at one end to the first spindle nut 42. In this case, the first coupler 52 is pivotably mounted on the first spindle nut 42 about an axis extending in the vertical direction. The other end of the first coupler 52 is attached at a first point of articulation to the footrest 32 and also pivotably mounted about an axis extending in the vertical direction. The first point of articulation is located in the transverse direction on the outside, in the vicinity of one of the inner rails 58.

In a similar manner, a second coupler 54 is attached at one end to the second spindle nut 44 and pivotably mounted on the second spindle nut 44 about an axis extending in the vertical direction. The other end of the second coupler 54 is attached at a second point of articulation to the footrest 32, and also pivotably mounted about an axis extending in the vertical direction. The first point of articulation is located in the transverse direction on the outside, in the vicinity of the other inner rail 58.

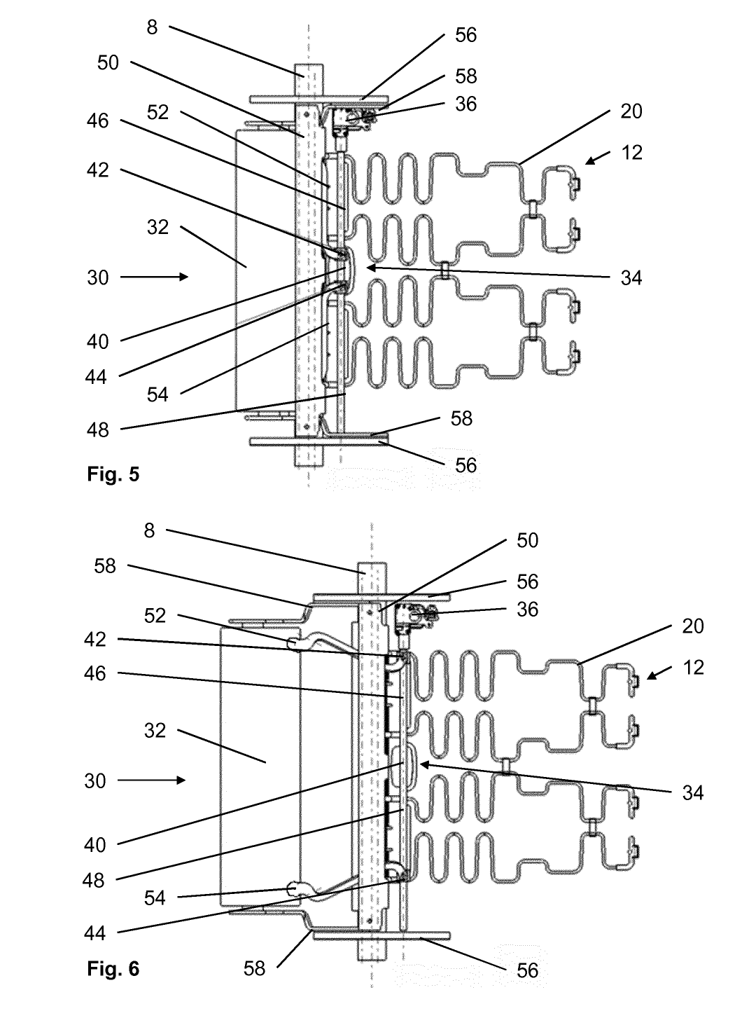

When the foot support 30 is retracted, the footrest 32 is in the position of non-use as shown in FIG. 5. The spindle nuts 42, 44, are located in the vicinity of one another and in the transverse direction in the vicinity of the center of the spindle 40. The couplers 52, 54, extend approximately in the transverse direction, outwardly toward their respective points of articulation on the footrest 32.

A cover 50 is provided in the vertical direction above the couplers 52, 54, and the footrest 32, and below the backrest 10 and the backrest adjustment fitting 19. The couplers 52, 54, and the footrest 32 are thus located in the vertical direction between the cover 50 and the rear transverse tube 8.

For extending the foot support 30 i.e. for moving the footrest 32 into the position of use, the motor 36 of the drive unit 34 is correspondingly activated, said motor then driving the spindle 60. The spindle 40 is then rotated about its longitudinal axis extending in the transverse direction. As a result, the threaded regions 46, 48, are rotated relative to the spindle nuts 42, 44, located thereon.

As a result, in each case the spindle nuts 42, 44, are displaced outwardly in the transverse direction along the longitudinal axis of the spindle 40. The spindle nuts 42, 44, thus move away from one another toward the outer rails 56.

The ends of the couplers 52, 54, connected to the spindle nuts 42, 44, move together with the spindle nuts 42, 44, outwardly in the transverse direction toward the outer rails 56. In this case, the couplers 52, 54, perform one respective rotation about the vertical axes about which they are pivotable relative to the spindle nuts 42, 44.

The other ends of the couplers 52, 54, which are connected to the footrest 32 then move in the longitudinal direction to the rear and push the footrest 32 in this direction. In this case, the couplers 52, 54, also perform one respective rotation about the vertical axes about which they are pivotable relative to their points of articulation on the footrest 32.

The footrest 32 guided by the linear guide, therefore, moves in the longitudinal direction to the rear out of the vehicle seat 1. In this case, the inner rails 58 fastened to the footrest 32 are displaced relative to the outer rails 56 fastened to the seat part 2. The footrest 32 stops moving when the position of use is reached, i.e. when the foot support 30 is extended as shown in FIG. 6.

For retracting the foot support 30, i.e. for moving the footrest 32 into the position of non-use, the electric motor is activated such that the spindle 40 rotates in the opposing direction.

In the exemplary embodiment described here, the spindle 40 is rotatably mounted. It is also conceivable to attach the spindle immovably to the seat part 2 or to the backrest 10 and to drive the spindle nuts arranged on the spindle in a rotatable manner. To this end, the spindle nuts may be arranged, for example, in one respective gear housing which is disclosed in DE 103 58 586 B4.

It is also conceivable to arrange just one spindle nut on the spindle, wherein only one coupler is required. In this case, the spindle requires only one threaded region.

The features disclosed in the above description, the claims and the drawings may be significant both individually and in combination with one another for implementing the invention in the various embodiments thereof.

While specific embodiments of the invention have been shown and described in detail to illustrate the application of the principles of the invention, it will be understood that the invention may be embodied otherwise without departing from such principles.

1-15. (canceled)

16. A foot support for a vehicle seat, the foot support comprising:
a footrest which is movable from a position of non-use into a position of use;
a linear guide guiding the footrest during the movement from the position of non-use into the position of use; and
a drive unit for driving the footrest, the drive unit comprising at least one spindle, at least one spindle nut arranged on the spindle and rotatable relative to the spindle, wherein the spindle extends in a transverse direction and the spindle comprises two threaded regions with threads oriented in opposing directions.

17. A foot support as claimed in claim 16, wherein the movement of the footrest from the position of non-use into the position of use is exclusively translatory.

18. A foot support as claimed in claim 16, wherein the movement of the footrest from the position of non-use into the position of use is carried out approximately counter to a direction of travel.

19. A foot support as claimed in claim 16, wherein the movement of the footrest from the position of use into the position of non-use is carried out approximately in a direction of travel.

20. A foot support as claimed in claim 16, wherein the drive unit comprises an electric motor.

21. A foot support as claimed in claim 16, wherein the spindle is rotatably mounted.

22. A foot support as claimed in claim 16, wherein the two threaded regions are arranged adjacent to one another relative to the longitudinal axis of the spindle.

23. A foot support as claimed in claim 16, wherein the linear guide comprises two outer rails and two inner rails, wherein the inner rails are displaceably guided in the outer rails.

24. A foot support as claimed in claim 16, wherein the drive unit further comprises another spindle nut to provide two spindle nuts, respectively arranged on one of the two threaded regions.

25. A foot support as claimed in claim 16, wherein at least one coupler is attached at one end to the spindle nut.

26. A foot support as claimed in claim 25, wherein the coupler is pivotably mounted on the spindle nut, about an axis extending in the vertical direction.

27. A foot support as claimed in claim 26, wherein the coupler has an opposite end pivotably mounted at a point of articulation on the footrest about an axis extending in the vertical direction.

28. A vehicle seat comprising a foot support comprising:
a footrest which is movable from a position of non-use into a position of use;
a linear guide guiding the footrest during the movement from the position of non-use into the position of use; and
a drive unit for driving the footrest, the drive unit comprising at least one spindle, at least one spindle nut arranged on the spindle and rotatable relative to the spindle, wherein the spindle extends in a transverse direction and the spindle comprises two threaded regions with threads oriented in opposing directions.

29. The vehicle seat as claimed in claim 28, further comprising:
a seat part; and
a backrest, wherein in the position of non-use the footrest is located in a space between the backrest and the seat part.

30. The vehicle seat as claimed in claim 28, further comprising:
a seat part; and
a backrest, wherein the seat part comprises a seat frame with two side parts extending approximately in a direction of travel, wherein the spindle is rotatably mounted on the two side parts of the seat frame.

31. A foot support for a vehicle seat, the foot support comprising:
a footrest;
a linear guide guiding the footrest between a position of non-use and a position of use;
a rotatably mounted spindle extending in a transverse direction and comprising a first threaded region and a second threaded region wherein the first threaded region has a first thread orientation direction opposing a second thread orientation direction of the second threaded region;
a first spindle nut arranged on the first threaded region; and
a second spindle nut arranged on the second threaded region.

32. A foot support as claimed in claim 31, wherein the movement of the footrest from the position of non-use into the position of use is exclusively translatory.

33. A foot support as claimed in claim 32, wherein:
the spindle, first spindle nut and second spindle nut are parts of a drive unit, the drive unit further comprising:
a first coupler pivotably mounted on the first spindle nut, about an axis extending in the vertical direction;
a second coupler pivotably mounted on the second spindle nut, about an axis extending in the vertical direction, wherein each coupler has an opposite end pivotably mounted at a point of articulation on the footrest about an axis extending in the vertical direction; and
an electric motor for rotating the rotatably mounted spindle.

34. A foot support as claimed in claim 33, wherein the two threaded regions are arranged adjacent to one another relative to the longitudinal axis of the spindle.

35. A foot support as claimed in claim 34, wherein the linear guide comprises two outer rails and two inner rails, wherein the inner rails are displaceably guided in the outer rails.
